(19) United States
(12) Patent Application Publication
(10) Pub. No.: US 2016/0181905 A1
(43) Pub. Date: Jun. 23, 2016

(54) CAPSULE-TYPE ACTUATOR

(71) Applicants: Chin-Hsing Feng, Taoyuan County (TW); Jii-Chyun Wang, Taoyuan County (TW)

(72) Inventors: Chin-Hsing Feng, Taoyuan County (TW); Jii-Chyun Wang, Taoyuan County (TW)

(21) Appl. No.: 14/575,709

(22) Filed: Dec. 18, 2014

(51) Int. Cl. H02K 35/00

(52) U.S. Cl. CPC H02K 35/00

(57) ABSTRACT

A capsule-type actuator includes a first capsule-shaped part, a second capsule-shaped part, and a connecting part. The interior of the connecting part is provided with a rotating member. A traction member is wound on the rotating member, and two ends of the traction member are connected to the interiors of the first capsule-shaped part and the second capsule-shaped part, respectively. When one capsule-shaped part is deformed to reduce its interior volume, the other capsule-shaped part will increase its interior volume accordingly, such that the traction member is pulled to actuate the rotating member. Through reciprocating motion, the rotating member is turned clockwise and counterclockwise. An output end of the rotating member is adapted to generate electric power.

### BACKGROUND OF THE INVENTION

1. Field of the Invention

The present invention relates to an actuator, and more particularly to a capsule-type actuator which can provide a multiple of a single route to generate electric power.

2. Description of the Prior Art

Due to increasing population and limited natural resources, people are still dependent on petrochemical or nature gas to generate power. However, the natural resources are gradually exhausted. The depletion of resources will eventually lead into a dilemma without electricity. Moreover, the pollutions caused by electricity generation and the disasters caused by nuclear power are numerous. Now, people pay more attention to the issues of environmental protection and safety. How to supply electricity effectively and how to conform to environment protection and energy-saving and safety demand are important issues.

In these days, people have a certain demand for various portable electric products, such as smart phones, tablet PCs, notebook computers, and so on. When people go out, they may have the demand for electricity. It is necessary to design a small, portable and green power generation device. Accordingly, the inventor of the present invention has devoted himself based on his many years of practical experiences to solve these problems.

### SUMMARY OF THE INVENTION

To improve pollution and other limitations of the conventional way to generate electric power, the primary object of the present invention is to provide a capsule-type actuator. The actuator provides green energy and is small in size and is efficient without pollution, which is able to generate electric power anywhere and anytime.

In order to achieve the aforesaid object, the present invention provides a traction member and a rotating member disposed between two capsule-shaped parts. By the two capsule-shaped parts to be deformed in turn, the traction member is pulled to actuate the rotating member. Through reciprocating motion, the rotating member is turned clockwise and counterclockwise to generate electric power.

The capsule-type actuator of the present invention comprises a first capsule-shaped part, a second capsule-shaped part, and a connecting part. Wherein, the first capsule-shaped part has a first chamber therein. The second capsule-shaped part has a second chamber therein. The connecting part has a connecting chamber therein. The connecting chamber is located between the first chamber and the second chamber. The first chamber, the second chamber, and the connecting chamber are all stored with a fluid.

The first capsule-shaped part is a normal capsule configuration or a bellows-type capsule configuration. The first capsule-shaped part is provided with at least one first rib thereon. The second capsule-shaped part is a normal capsule configuration or a bellows-type capsule configuration. The second capsule-shaped part is provided with at least one second rib thereon. The first capsule-shaped part and the second capsule-shaped part can be deformed and then restored to their original shape. Either of the first capsule-shaped part and the second capsule-shaped part comprises a spiral spring structure therein. Normally, either capsule-shaped part ascended by elasticity is able to suck the fluid, so that its interior is in a full state and the other capsule-shaped part is in a flat compressed state.

The connecting chamber is provided with a rotating member. The rotating member is wound with a traction member. The traction member is a rope. Two ends of the traction member are connected to the first chamber and the second chamber, respectively. The first chamber is provided with at least one first turning member. The second chamber is provided with at least one second turning member. The two ends of the traction member respectively pass through the first turning member and the second turning member in sequence, and secured to the first turning member and the second turning member. Preferably, the first chamber is provided with a plurality of first turning members which are disposed at the top and the bottom of the first chamber. Preferably, the second chamber is provided with a plurality of second turning members which are disposed at the top and the bottom of the second chamber.

The rotating member has an output end. The output end is connected with a generator unit.

Except the turning member located at the distal end of the traction member to provide a fixing function, the other turning members provide a turning function.

### BRIEF DESCRIPTION OF THE DRAWINGS

FIG. 1 is a perspective view according to a preferred embodiment of the present invention;

FIG. 2 is a sectional view according to the preferred embodiment of the present invention;

FIG. 3 is a schematic view showing that the first capsule-shaped part of the present invention is pressed; and

FIG. 4 is a schematic view showing that the second capsule-shaped part of the present invention is pressed.

### DETAILED DESCRIPTION OF THE PREFERRED EMBODIMENTS

Embodiments of the present invention will now be described, by way of example only, with reference to the accompanying drawings.

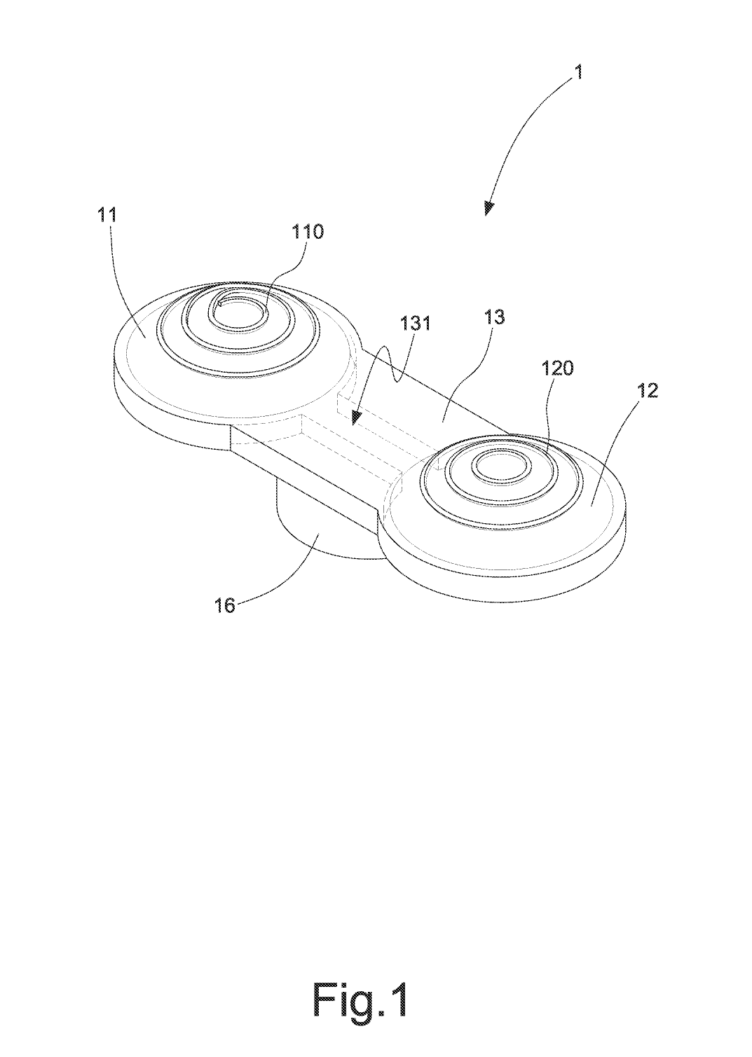

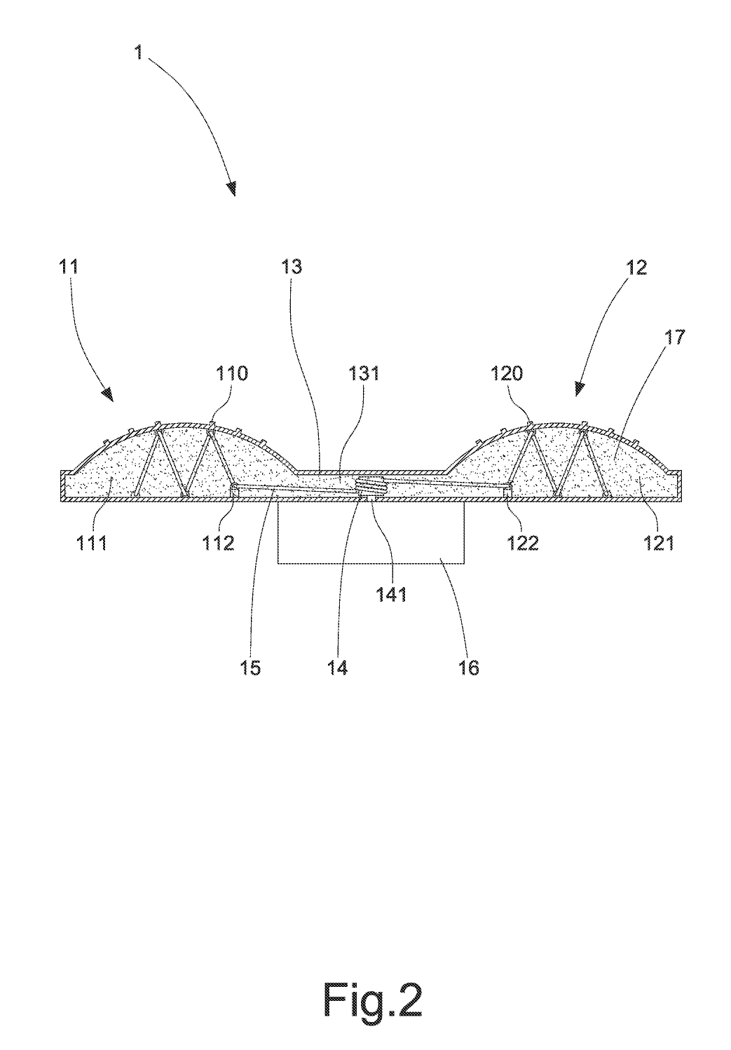

As shown in FIG. 1 and FIG. 2, the capsule-type actuator 1 according to a preferred embodiment of the present invention comprises a first capsule-shaped part 11, a second capsule-shaped part 12, and a connecting part 13.

The first capsule-shaped part 11 has a first chamber 111 therein. The second capsule-shaped part 12 has a second chamber 121 therein. The connecting part 13 has a connecting chamber 131 therein. The connecting chamber 131 is located between the first chamber 111 and the second chamber 121. The first chamber 111, the second chamber 121, and the connecting chamber 131 are all stored with a fluid 17. The first capsule-shaped part 11 is provided with at least one first rib 110 thereon. The second capsule-shaped part 12 is provided with at least one second rib 120 thereon.

The connecting chamber 131 is provided with a rotating member 14. The rotating member 14 is wound with a traction member 15. The traction member 15 is a rope. Two ends of the traction member 15 are connected to the first chamber 111 and the second chamber 121, respectively. The first chamber 111 is provided with at least one first turning member 112. The second chamber 121 is provided with at least one second turning member 122. The two ends of the traction member 15 respectively pass through the first turning member 112 and the second turning member 122 in sequence, and secured at the first turning member 112 and the second turning member 122.

The rotating member 14 has an output end 141. The output end 141 is connected with a generator unit 16.

The first capsule-shaped part 11 and the second capsule-shaped part 12 can be deformed and then restored to their original shape. Normally, the actuator 1 is in an isobaric state as shown in FIG. 2.

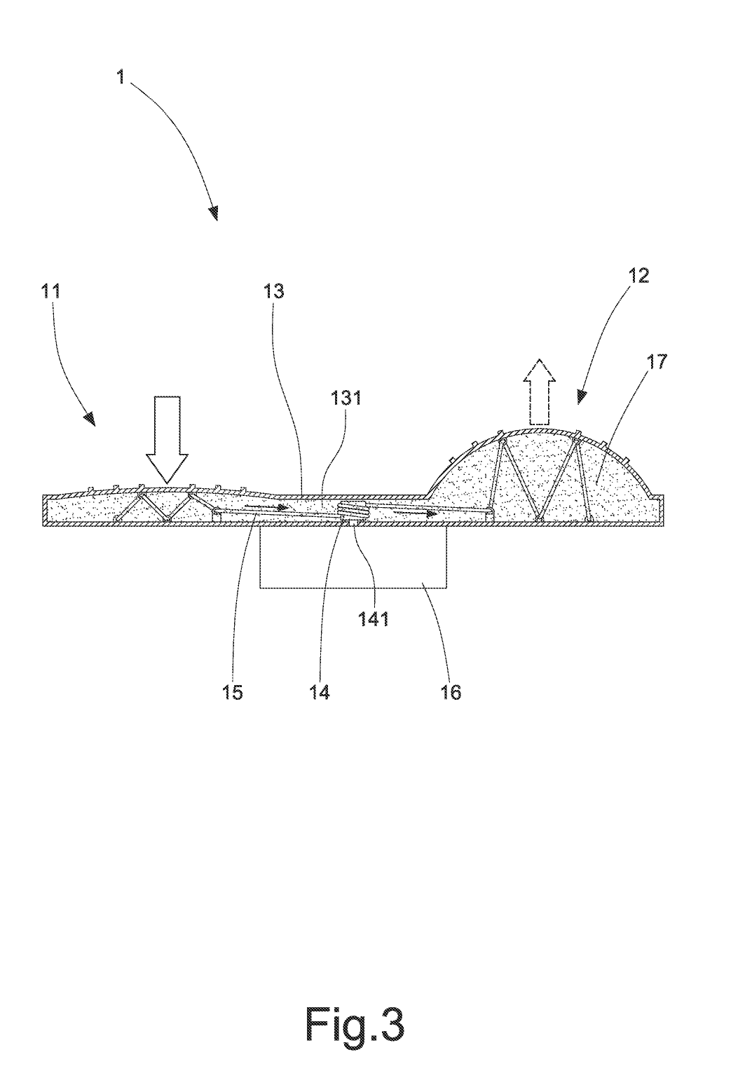

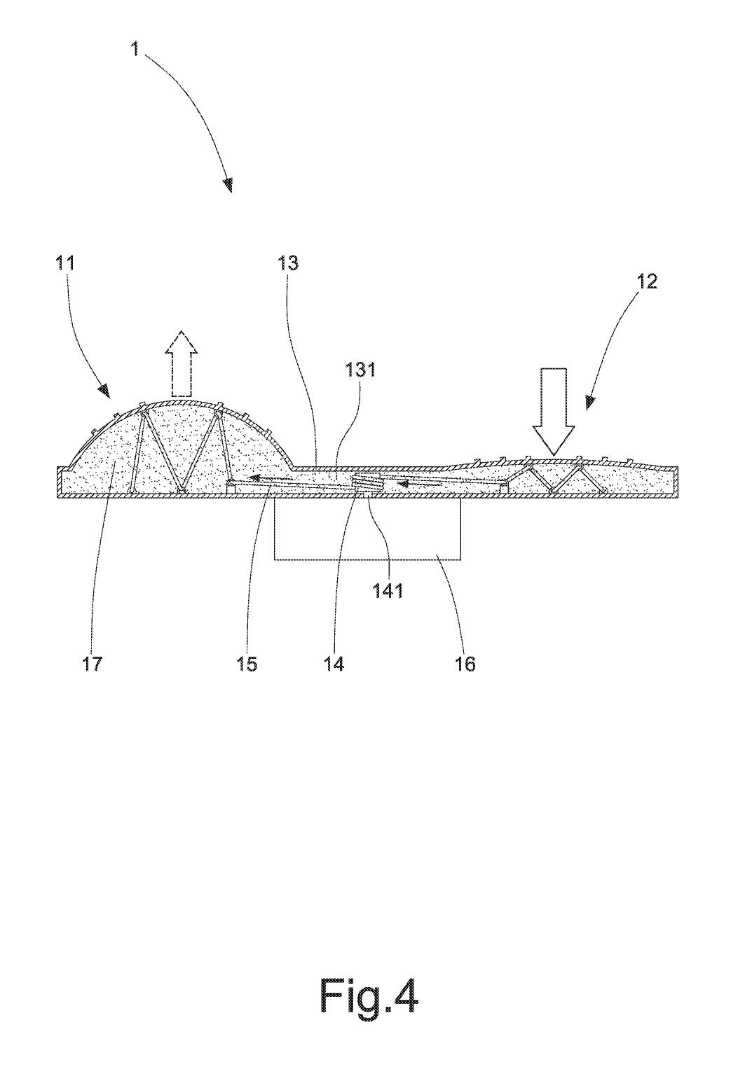

As shown in FIG. 3, for example, the actuator 1 is placed on the ground and waiting for being stepped by a walker or pressed by a vehicular wheel. When the first capsule-shaped part 11 is applied with an external force, the first capsule-shaped part 11 will be pressed and deformed to reduce the volume of the first chamber 111, and the fluid will flow to the second chamber 121 through the connecting chamber 131 to increase the volume of the second chamber 121 accordingly. The traction member 15 is pulled toward the second chamber 121 and the rotating member 14 is rotated to actuate. Similarly, as shown in FIG. 4, when the second capsule-shaped part 12 is applied with an external force, the volume of the first chamber 111 will increase and the traction member 15 will be pulled toward the first chamber 111. Through reciprocating motion, the rotating member 14 is turned clockwise and counterclockwise. The output end 141 of the rotating member 14 is connected with the generator unit 16 to generate power.

The feature of the present invention is that the actuator is provided with a plurality of first turning members 112 and second turning members 121 and only a single traction route is required to provide a multiple of the route so as to enhance its efficiency. The present invention has economic benefits.

What is claimed is:

1. A capsule-type actuator, comprising:
a first capsule-shaped part having a first chamber therein, the first chamber being provided with at least one first turning member;
a second capsule-shaped part having a second chamber therein, the second chamber being provided with at least one second turning member;
a connecting part having a connecting chamber therein, the connecting chamber being located between the first chamber and the second chamber to communicate with the first chamber and the second chamber;
a rotating member, the rotating member being disposed in the connecting chamber, the rotating member having an output end; and
a traction member, the traction member being wound on the rotating member and having two ends, the two ends of the traction member being connected to the first turning member and the second turning member, respectively.

2. The capsule-type actuator as claimed in claim 1, wherein the first chamber, the second chamber, and the connecting chamber are stored with a fluid.

3. The capsule-type actuator as claimed in claim 1, wherein the first capsule-shaped part is provided with at least one first rib thereon.

4. The capsule-type actuator as claimed in claim 1, wherein the second capsule-shaped part is provided with at least one second rib thereon.

5. The capsule-type actuator as claimed in claim 1, wherein the output end of the rotating member is connected with a generator unit.

6. The capsule-type actuator as claimed in claim 1, wherein the first capsule-shaped part and the second capsule-shaped part are deformable.

7. The capsule-type actuator as claimed in claim 1, wherein the first chamber is provided with a plurality of first turning members which are disposed at a top and a bottom of the first chamber.

8. The capsule-type actuator as claimed in claim 1, wherein the second chamber is provided with a plurality of second turning members which are disposed at a top and a bottom of the second chamber.

9. The capsule-type actuator as claimed in claim 1, wherein either of the first capsule-shaped part and the second capsule-shaped part comprises a spiral spring structure therein.
